(19) United States
(12) Patent Application Publication
(10) Pub. No.: US 2008/0313584 A1
(43) Pub. Date: Dec. 18, 2008

(54) Logic verification method

(75) Inventor: Masato Otsuka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 12/076,552

(22) Filed: Mar. 19, 2008

(30) Foreign Application Priority Data
Mar. 30, 2007 (JP) 2007-093047

(51) Int. Cl. G06F 17/50

(52) U.S. Cl. 716/5

(57) ABSTRACT

A logic verification method is disclosed to a computer to conduct a logic verification process by using a state machine based on a verification property, including the steps of (a) displaying at lease one waveform generated based on a logic verification result of the logic verification process, (b) displaying the verification property, and controlling the step (a) and the step (b) in response to an operation input. The step (c) controls the step (b) to display a first respective portion of a description of the verification property corresponding to a first desired portion of the at least one waveform selected by the operation input by correlating to the first desired portion, by a different display method from other portions in response to the operation input onto the at least one waveform being displayed in the step (a).

### CROSS-REFERENCE TO RELATED APPLICATION

The present application is based on Japanese Priority Application No. 2007-093047 filed Mar. 30, 2007, the entire contents of which are hereby incorporated by reference.

### BACKGROUND OF THE INVENTION

1. Field of the Invention

The present invention generally relates to a logic verification method for conducting a logic verification with respect to a logic circuit and enabling a user to easily analyze a verification property violation detected by the logic verification on a waveform.

2. Description of the Related Art

Conventionally, when a logic circuit is designed, an operation called a logic verification is conducted to verify whether or not a function, a timing, and a like comply with a specification. In the logic verification, a verification property is created to confirm whether or not the specification is satisfied, and the logic circuit is verified in an environment embedding a checker for checking whether or not the verification property is satisfied. In general, a cause of a violation is analyzed by referring to a waveform if the verification property violation is detected. However, in order to specify the cause of the violation from the waveform, it is required that a well-trained user having experience carries out the determination since it is not simple to determine the cause of the violation.

In order to easily conduct the analysis using the waveform, for example, Japanese Laid-open Patent Application No. 2004-326650 suggests to display an error message 80 (in FIG. 8 of Japanese Laid-open Patent Application No. 2004-326650) based on a verification result, to display an expected signal waveform by superimposing with an actual waveform based on an expected value of a signal value which is stored in waveform data including annotation information, and to display an arrow sign indicating a logical relationship between an event and a waveform based on information of the event stored in the waveform data including the annotation information.

However, in the conventional logic verification method described above, the user is required to have a knowledge concerning a correspondence between a description of the verification property and the waveform and to analyze the verification result by using the correspondence between the verification property and the waveform while memorizing the verification property to be subjected in his mind. In a case that the verification property is complicated and there are a large number of signal lines, it is difficult for the user to build up the correspondence between the verification property and a violated waveform in his mind, and human error is easily occurred in the analysis.

### SUMMARY OF THE INVENTION

According to one aspect of the present invention, there is provided a logic verification method for causing a computer to conduct a logic verification process by using a state machine based on a verification property, said method including the steps of: (a) displaying at lease one waveform generated based on a logic verification result of the logic verification process; (b) displaying the verification property; and (c) controlling the step (a) and the step (b) in response to an operation input, wherein the step (c) controls the step (b) to display a first respective portion of a description of the verification property corresponding to a first desired portion of the at least one waveform selected by the operation input by correlating to the first desired portion, by a different display method from other portions in response to the operation input onto the at least one waveform being displayed in the step (a).

According to another aspect of the present invention, there is provided a logic verification method for causing a computer to conduct a logic verification process by using a state machine based on a verification property, said method including the steps of: (a) generating waveform data by executing the logic verification process and setting a first range of precondition state determined based on the state machine to the waveform data; (b) displaying at least one waveform generated based on the waveform data; and (c) controlling the step (b) to display the at least one waveform so that the first range of the precondition state is shown by a different display method from other ranges.

According to a further aspect of the present invention, there is provided a logic verification method for causing a computer to conduct a logic verification process by using a state machine based on a verification property, said method including the steps of: (a) generating waveform data by executing the logic verification process and setting a portion corresponding to a violation occurrence state determined based on the state machine; and (b) displaying at least one waveform based on the waveform data and displaying information indicating the violation occurrence state at the portion corresponding to the violation occurrence state, wherein the step (a) sets portions corresponding to predetermined counts to the waveform data when the violation occurrence state caused by a same factor is detected equal to or more than the predetermined counts.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a hardware configuration of a logic verification apparatus according to an embodiment of the present invention;

FIG. 2 is a diagram for briefly explaining a logic verification process;

FIG. 3 is a diagram showing a display example in that a property display and a waveform display are correlated to each other in response to a display operation;

FIG. 4 is a diagram showing a correspondence example for correlating the partial description in the verification property with the portion of the waveform display;

FIG. 5 is a diagram showing a waveform display example corresponding to conditions described by the verification property;

FIG. 6 is a diagram showing a display example in which the property display and the waveform display are correlated with each other by applying a method described with reference to FIG. 5;

FIG. 7 is a diagram showing a correspondence example to highlight portions by correlating the property display and the waveform display with each other;

FIG. 8 is a diagram showing a correspondence example in a case in that verification property violations occur in different state transitions;

FIG. 9 is a diagram showing an example of waveform data in a case in that displays of some verification property violations are not cancelled;

FIG. 10 is a diagram showing a transition path counter table; and

FIG. 11 is a diagram showing a waveform data example in a case of cancelling the displays of some verification property violations.

### DESCRIPTION OF THE PREFERRED EMBODIMENT

An embodiment according to the present invention will be described with reference to the accompanying drawings.

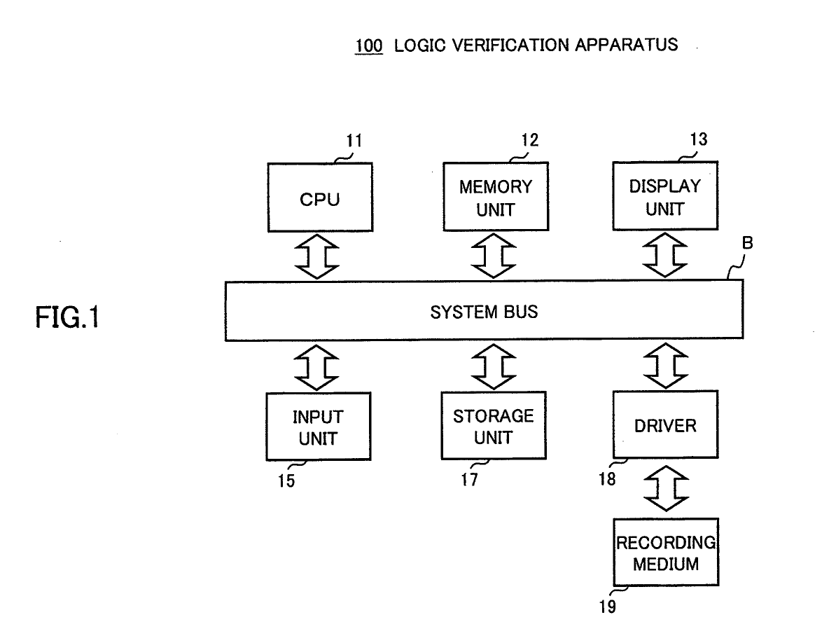

A logic verification apparatus 100 conducting a logic verification method according to the present invention is a computer apparatus and has a hardware configuration as shown in FIG. 1. FIG. 1 is a block diagram showing the hardware configuration of the logic verification apparatus according to an embodiment of the present invention.

In FIG. 1, the logic verification apparatus 100 includes a CPU (Central Processing Unit) 11, a memory unit 12, a display unit 13, an input unit 15, a storage unit 17, and a driver 18, which are mutually connected via a system bus B.

The CPU 11 controls the logic verification apparatus 100 in accordance with a program stored in the memory unit 12. The memory unit 12 includes a RAM (Random Access Memory), a ROM (Read-Only Memory), and a like, and stores the program executed by the CPU 11, data necessary for a process conducted by the CPU 11, data acquired in the process of the CPU 11. Also, a part of an area of the memory unit 12 is assigned as a work area used in the process of the CPU 11.

The display unit 13 displays various necessary information under a control of the CPU 11. The input unit 15 includes a mouse, a keyboard, and a like, and is used by a user to input necessary information to enable the logic verification apparatus 100 to conduct the process.

For example, the storage unit 17 includes a hard disk unit, and stores data including the program and a like to execute various processes.

For example, a program realizing a process in the logic verification method, which is conducted by the logic verification apparatus 100, can be provided to the logic verification apparatus 100 by using a recording medium 19 such as a CD-ROM (Compact Disk Read-Only Memory) or a like. That is, when the recording medium 19 storing the program is set in the driver 18, the driver 18 reads out the program from the recording medium 19, and the program is installed into the storage unit 18 via the system bus B. Then, when the program is executed, the CPU 11 begins the process in accordance with the program installed in the storage unit 17.

It should be noted that it is not limited to the CD-ROM as the recording medium 19 and any recording medium being a computer-readable medium can be used. In a case in that the logic verification apparatus 100 includes a communication unit for conducting a network communication with an external device, the program realizing the process according to the present invention may be downloaded through a network by using the communication unit and installed into the storage unit 17. Also, in a case in that the logic verification apparatus 100 includes an interface such as a USB (Universal Serial Bus) for connecting to an external storage device, the program may be read out from the external storage device by a USB connection.

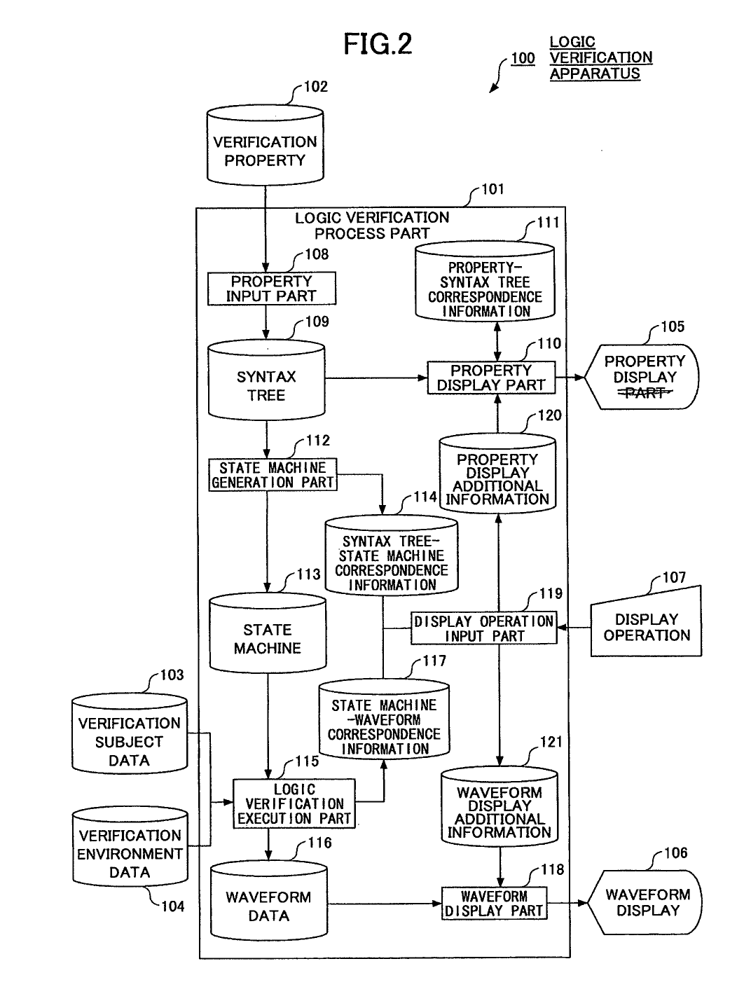

The logic verification process conducted by the CPU 11 of the logic verification apparatus 100 will be described with reference to FIG. 2. FIG. 2 is a diagram for briefly explaining the logic verification process. In FIG. 2, the logic verification apparatus 100 includes a logic verification process part 101 that conducts logic verification by the CPU 11 conducting a simulation based on verification property 102.

The logic verification process part 101 includes a property input part 108, a property display part 110, a state machine generation part 112, a logic verification execution part 115, a waveform display part 118, and a display operation input part 119. Information generated by the logic verification process part 101 is stored in a storage area of the memory unit 12 or the storage unit 17.

The property input part 108 inputs the verification property 102 to the logic verification process part 101, generates a syntax tree 109 from the verification property 102, and stores the syntax tree 109 in the storage area. The verification property 102 is stored in an external storage unit or the storage unit 17 of the logic verification apparatus 100 and is input to the logic verification process 101 by the property input part 108.

The state machine generation part 112 generates a state machine 113 showing a state transition in accordance with the verification property 102 by using the syntax tree 109 to verify the verification property 102. Also, the state machine generation part 112 generates a syntax tree-state machine correspondence information 114 indicating a correspondence between elements of the syntax tree 109 and the state machine 113 and stores the syntax tree-state machine correspondence information 114 in the storage area.

The logic verification execution part 115 reads a verification subject data 103 including a module source in interest of the verification and verification environment data 104 such as a setting file, and conducts the logic verification with respect to the module source by using the verification subject data 103, the verification environment data 104, and the state machine 113. The logic verification execution part 115 generates waveform data 116 based on a logic verification result. In a case in that a violation is detected in the logic verification conducted by the logic verification execution part 115, the waveform data 116 includes data of the violation.

For example, the verification subject data 103 is information showing a RTL (Register Transfer Level) which describes a circuit operation with a signal transfer among registers based on a clock, or a like. For example, the verification environment data 104 is a test bench or a like.

Also, the logic verification execution part 115 generates a state machine-waveform correspondence information 117 indicating a correspondence between elements of the state machine 113 and elements of the waveform data 116. The waveform display part 118 outputs a waveform display 106 based on the waveform data 116 at the display unit 13.

When the user selects a part or the entire waveform on the waveform display 106, a display operation 107 of the user using the input unit 15 is received by the display operation input part 119. The display operation input part 119 generates property display additional information 120 concerning a portion selected on the waveform display 106 showing the syntax tree 109, by using the syntax tree-state machine correspondence information 114 and the state machine-waveform correspondence information 117 in response to the display operation 107.

The property display part 110 displays the portion which corresponds to the display operation 107 on a property display 105, so as to distinguish from other portions based on property-syntax tree correspondence information 111 and the property display additional information 120. For example, the property display part 110 displays the property display 105 so that the portion corresponding to the display operation 107 is emphasized with a different color, a different letter shape (a thickness, a letter style), or a like from other portions.

When the user selects a part or the entire description of the verification property on the property display 105, the display operation 107 is sent to the display operation input part 119. The display operation input part 119 generates waveform display additional information 121 concerning a portion selected on the property display 105 in the waveform data 116, by using the syntax tree-state machine correspondence information 114 and the state machine-waveform correspondence information 117 in response to the display operation 107.

The waveform display part 118 displays the portion which corresponds to the display operation 107 on the waveform display 106, based on the waveform display additional information 121. For example, the waveform display 118 displays the waveform display 106 at the display unit 13 so as to emphasize the portion corresponding to the display operation 107 with a different color, a different line shape (a thickness, or a line type) or a like from other portions.

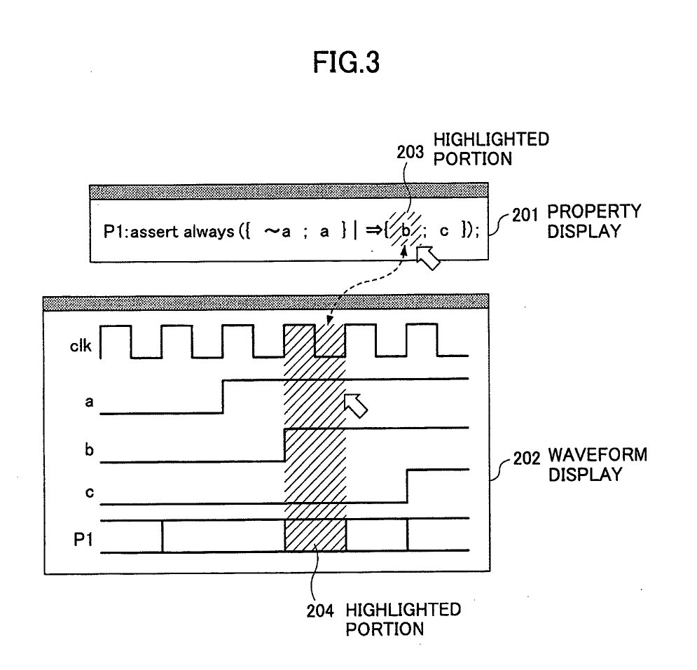

FIG. 3 is a diagram showing a display example in that a property display and a waveform display are correlated to each other in response to a display operation. In FIG. 3, when the user selects a portion on either one of the property display 201 and the waveform display 202, the selected portion and a correlated portion are emphasized and displayed on the property display 201 and the waveform display 202, respectively.

For example, when the user selects a partial description “b” of the description of the verification property on the property display 201 by using the mouse or the like, the property display part 110 highlights the partial description “b” in response to the display operation 107 on the property display 201. The display operation input part 119 acquires an element “b” of the syntax tree 109 corresponding to the partial description “b” of the property display 201 by using the property-syntax tree correspondence information 111, further acquires state data which is applied when an element “b” of the state machine 113 corresponding to the element “b” of the syntax tree 109 is satisfied by using the syntax tree-state machine correspondence information 114, and generates the waveform display additional information 121 concerning the partial description “b” of the property display 201 in the waveform data which corresponds to this state, by using state machine-waveform correspondence information 117.

Accordingly, on the waveform display 202, a highlighted portion 204 is conducted to a correlated portion based on the waveform display additional information 121 by the waveform display 118.

On the other hand, when the user selects a partial description of the verification property of the waveform display 202 by using the mouse or the like, the waveform display part 118 highlights portions of waveforms in response to the display operation 107 conducted on the waveform display 202. The display operation input part 119 acquires a state corresponding to the portions of the waveforms which are selected by the user on the waveform display 202, by using the state machine-waveform correspondence information 117, further acquires the element “b” of the syntax tree 109 corresponding to the acquired state, by using the syntax tree-state machine correspondence information 114, and generates the property display additional information 120 including information indicating the element “b” of the syntax tree 109, corresponding to the selected portions of the waveforms.

Accordingly, on the property display 201, a highlighted portion 203 is conducted to a correlated portion based on the property display additional information 120 by the property display 110.

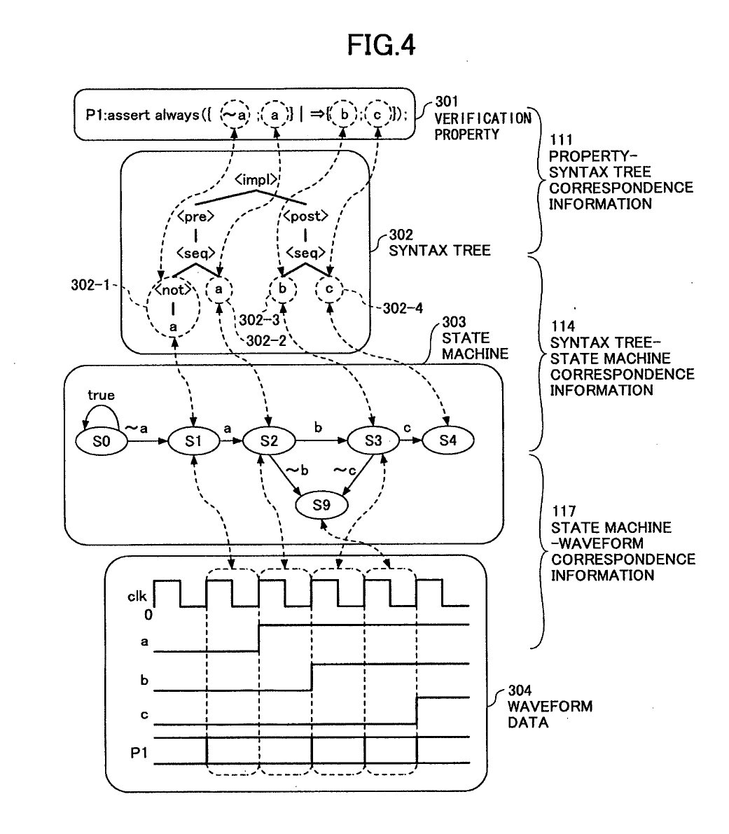

A correspondence among the property-syntax tree correspondence information 111, the syntax tree-state machine correspondence information 114, and the state machine-waveform correspondence information 117 will be described with reference to FIG. 4. FIG. 4 is a diagram showing a correspondence example for correlating the partial description in the verification property with the portion of the waveform display. In FIG. 4, the correspondence will be described by illustrating a description of a verification property 301.

In the verification property 301, a description {˜a;a} indicates “when ‘a’ is zero, ‘a’ is set to be one after one cycle” as a precondition, and a description {b;c} indicates “at one cycle after ‘b’ becomes one, ‘c’ becomes one” as a postcondition if ‘a’ becomes zero from one.

A syntax tree 302 is generated so that ends of elements 302-1, 302-2, 302-3, and 302-4 are represented as elements ‘˜a’, ‘a’, ‘b’, and ‘c’ of the verification property 301. The elements ‘˜a’, ‘a’, ‘b’, and ‘c’ of the verification property 301 are changed synchronizing with a clock. The elements 302-1 and 203-2 are branched elements as the precondition. The elements 302-3 and 302-4 are branched elements as the postcondition.

A state machine 303 is generated so that an initial state S0, states S1, S2, S3 and S4 of respective elements 302-1, 302-2, 303-3, and 302-4, and an error state S9 which is not included in the syntax tree 302 are included.

The waveform data 304 is generated based on a waveform of a clock clk as a reference, values which are generated by the logic verification execution part 115 for signals ‘a’, ‘b’, and ‘c’ and states of P1 shown as the verification property 301.

The property-syntax tree correspondence information 111 indicates a correspondence between the elements ‘˜a’, ‘a’, ‘b’, and ‘c’ of the verification property 301 and the elements 302-1, 302-2, 302-3, and 302-4 of the syntax tree 302.

The syntax tree-state machine correspondence information 114 indicates a correspondence between the elements 302-1, 302-2, 302-3, and 302-4 of the syntax tree 302 and the states S1, S2, S3, and S4 of the state machine 303. In this case, there is no information of a correspondence between the syntax tree 302 and each of the initial state S0 and the error state S9 in the syntax tree-state machine correspondence information 114.

The state machine-waveform correspondence information 117 indicates a correspondence between waveforms of the signals ‘a’, ‘b’, and ‘c’ synchronizing with the clock clk in the waveform data 304 and the states S1, S2, S3, and S4 of the state machine 303. The correspondence indicated in state machine-waveform correspondence information 117 is changed in accordance with the waveforms of the signals ‘a’, ‘b’, and ‘c’ synchronizing with the clock clk. Data of the waveforms are stored in the waveform data 304. In the correspondence example shown in FIG. 4, since a case in that the verification property violation is detected is illustrated, the error state S9 is corresponded to a part of the waveform data 304. If the verification property violation is not detected, the error state S9 is not corresponded to any part of the waveform data 304.

For example, the waveform data 302 is a waveform text file storing values of the signals ‘a’, ‘b’, and ‘c’ for each of cycles 0, 1, 2, 3, . . . and state values of P1 indicated by the verification property 301. The state machine-waveform correspondence information 117 is generated by making the values of the signals ‘a’, ‘b’, and ‘c’ for each of cycles 0, 1, 2, 3, . . . corresponded to the states S0, S2, S3, S4, and S9 of the state machine 303.

If the error state S9 of the state machine 303 is corresponded to the waveform data 304, it may be conducted to trace from the state S3 prior to (one cycle before) the error state S9 by referring to the waveform data 302 being the waveform text file in order to make the error state S9 of the state machine 303 corresponded to the syntax tree 302.

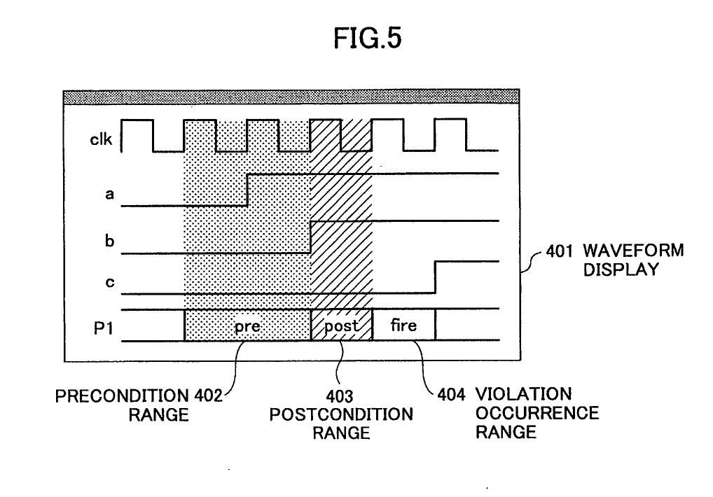

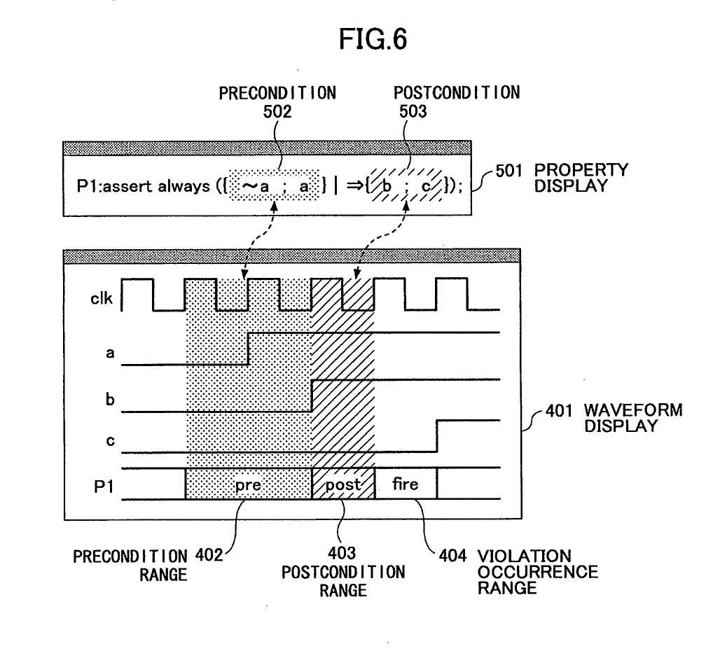

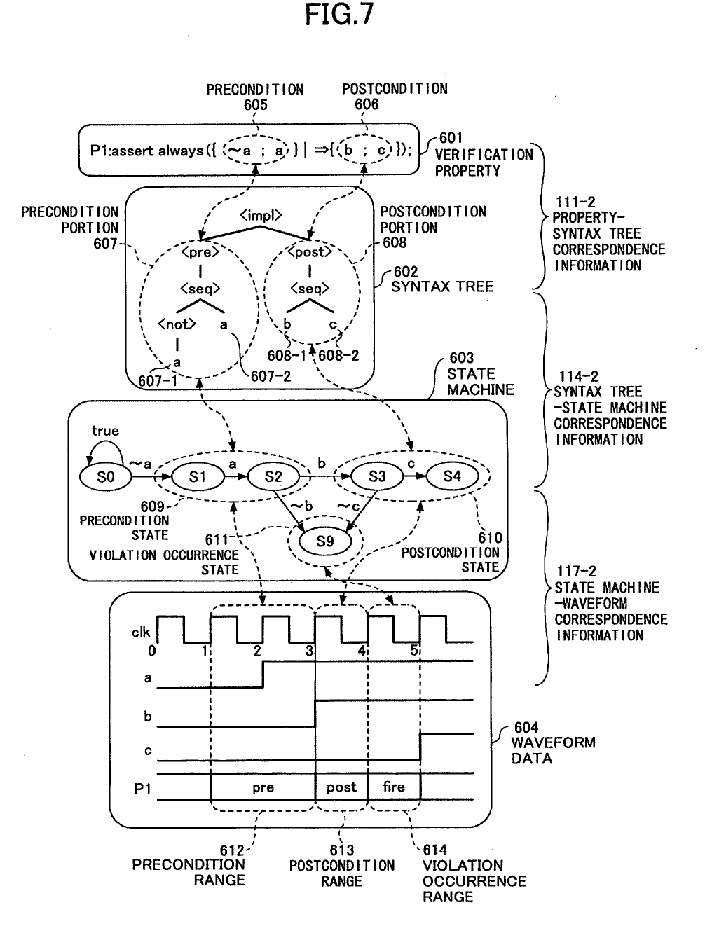

Next, a method for displaying a property display and a waveform display by corresponding to the verification property 301 will be described with reference to FIG. 5, FIG. 6, and FIG. 7.

FIG. 5 is a diagram showing a waveform display example corresponding to conditions described by the verification property. In a waveform display 401 shown in FIG. 5, by P1 showing the verification property, “pre” is shown in a precondition range 402 in which a precondition is executed, “post” is shown in a postcondition range 403 in which a postcondition is executed, and “fire” is shown in a violation occurrence range 404 in which a violation occurs.

Also, in order to easily distinguish the precondition range 402 and the postcondition range 403, the precondition range 402 and the postcondition range 403 are highlighted with different background colors from other ranges. Moreover, in order to visually determine the precondition range 402, the precondition range 402 is shown by applying the same background color partially to P1 of the verification property, the clock clk, the signals ‘a’, ‘b’, and ‘c’. The postcondition range 403 is shown with a different background color from the precondition range 402.

FIG. 6 is a diagram showing a display example in which the property display and the waveform display are correlated with each other by applying the method described with reference to FIG. 5. In FIG. 6, the waveform display 401 shown in FIG. 5 and a property display 501 are simultaneously displayed at the display unit 13. Moreover, in the description of the verification property 102 shown in the property display 501, a precondition 502 indicating a description portion corresponding to the precondition range 402 in the waveform display 401 is highlighted with the same background color as the precondition range 402 in the waveform display 401. Also, in the description of the verification property 102 shown in the property display 501, a postcondition 503 indicating a description portion corresponding to the postcondition range 403 in the waveform display 401 is highlighted with the same background color as the postcondition range 403 in the waveform display 401.

FIG. 7 is a diagram showing a correspondence example to highlight portions by correlating the property display and the waveform display with each other. In FIG. 7, a description of a verification property 601 is the same as that of the verification property 301 shown in FIG. 4 as another example of the verification property 102.

The property-syntax tree correspondence information 111-2 makes a precondition 605 including a description portion of a precondition “˜a;a” of the verification property 601 correspond to a precondition portion 607 including branch portions of elements 607-1 and 607-2 for the precondition “˜a;a” of a syntax tree 602, and also makes a postcondition 606 including a description portion of a postcondition “b;c” of the verification property 601 correspond to a postcondition portion 608 including branch portions of elements 608-1 and 608-2 of the syntax tree 602.

When the syntax tree 602 is generated, the property input part 108 (FIG. 2) generates each of the elements “˜a” and “a” of the precondition 605 under a branch “<pre>” with respect to the description portion of the precondition 605 in accordance with a description format of the verification property 601, and generates elements “b” and “c” of the postcondition 606 under a branch “<post>” with respect to the description portion of the postcondition 606. Accordingly, the property-syntax tree correspondence information 111-2 can be generated by recognizing a range until the elements “˜a” and “a” of the precondition 605 under the branch “<pre>” as the precondition portion 607 and a range until the elements “b” and “c” of the postcondition 606 under the branch “<post>”.

A syntax tree-state machine correspondence information 114-2 makes the precondition portion 607 of the syntax tree 602 correspond to a precondition state 609 of a state machine 603, and also makes the postcondition portion 608 of the syntax tree 602 correspond to the precondition state 610 of the state machine 603. The precondition state 609 of the state machine 603 includes states S1 and S2 in a case in that the elements 607-1 and 607-2 at ends of the precondition portion 607 of the syntax tree 602 are satisfied, respectively. Similarly, the postcondition state 610 of the state machine 603 includes states S3 and S4 in a case in that the elements 608-1 and 608-2 at ends of postcondition portion 608 are satisfied, respectively. In this case, there are no correspondences from each of an initial state S0 and a violation occurrence state 611 to the syntax tree 602 in the syntax tree-state machine correspondence information 114-2.

A state machine-waveform occurrence information 117-2 makes the precondition state 609 of the state machine 603 correspond to a precondition range 612 of the waveform data 604, makes the postcondition state 610 of the state machine 603 correspond to a postcondition range 613 of the waveform data 604, and makes the violation occurrence state 611 of the state machine 603 correspond to a violation occurrence range 614 of the waveform data 604. Since the verification property violation is detected as illustrated, the violation occurrence state 611 is corresponded to the violation occurrence range 614 of the waveform data 304. If the verification property violation is not detected, the violation occurrence state 611 is not corresponded to the violation occurrence range 614 of the waveform data 604.

For example, in the machine state-waveform correspondence information 117-2, the precondition range 612 is defined during a second cycle and a third cycle of a clock clk, the postcondition range 613 is defined during a fourth cycle of the clock clk, and the violation occurrence range 614 is defined during a fifth cycle of the clock clk. Thus, as described above, the state machine 603 is corresponded to the waveform data 604.

As described above, by corresponding to each of states which indicates a precondition, a postcondition, or a violation occurrence and which is possibly transited in the logic verification of the verification property 601, it is possible to correlate the waveform display 401 with the property display 501 by corresponding to the precondition, the postcondition, and the violation occurrence. Moreover, each of portions corresponding to the precondition or the postcondition can be easily distinguished in both the waveform display 401 and the property display 501, which are correlated to each other.

In a case in that the verification property violation occurs in one state transition and multiple verification property violations occur in another state transition, the verification property violation and the multiple verification property violations are not easily distinguishable and make it difficult to verify a logic property.

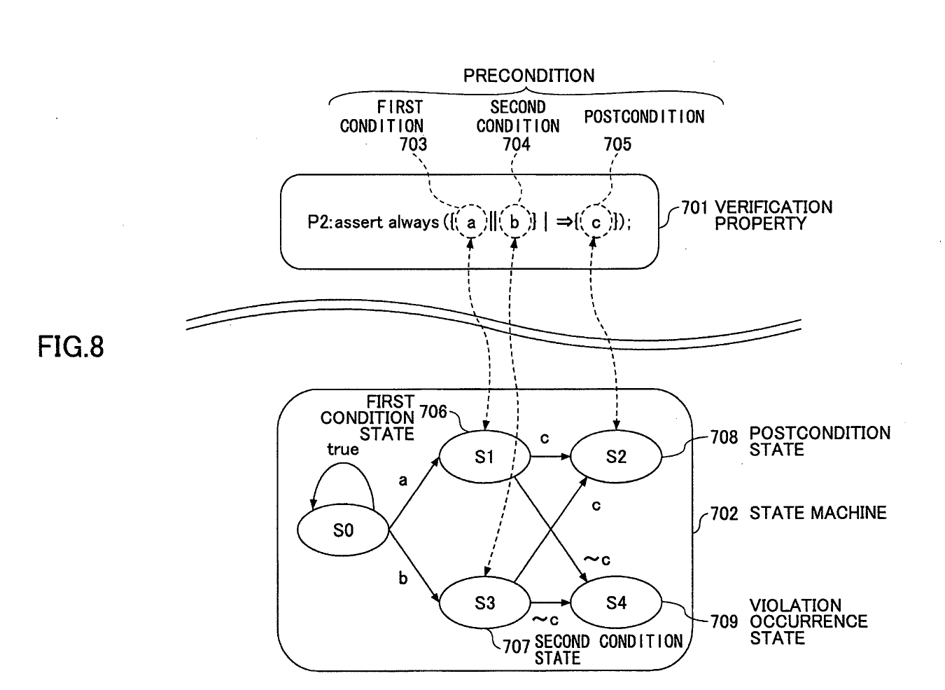

In this case, the logic verification execution part 115 counts the verification property violation for each of transition paths, and generates the waveform data 116 so as to include the verification property violation when a counter indicates one (an initial count) or is equal to or greater than a predetermined value. That is, when the counter is greater than one, the verification property violation is not included in the waveform data 116. An example of cancelling a display of the verification property violation will be described with reference to FIG. 8 through FIG. 11.

FIG. 8 is a diagram showing a correspondence example in a case in that the verification property violations occur in different state transitions. In FIG. 8, a correspondence between the property-syntax tree correspondence information 111 and the syntax tree-state machine correspondence information 114 is omitted. For the sake of convenience, only a correspondence between a verification property 701 and a state machine 702 is illustrated and explained.

In FIG. 8, the verification property 701 is an example in which a postcondition 705 is conducted at one cycle after a first condition 703 or a second condition 704 is satisfied as the precondition. For example, the verification property 701 indicates that a signal ‘c’ is ON at one cycle after a signal ‘a’ is ON or a signal ‘b’ is ON.

In the state machine 702 corresponding to the verification property 701, a state is branched to a first condition state 706 (state S1) corresponding to a first condition 703 of the verification property 701 and a second condition 707 (state S3) corresponding to a second condition 704 of the verification property 701, from the initial state S0.

From the first condition state 706 (state S1), the state transits to a postcondition state 708 corresponding to the postcondition 705 of the verification property 701. On the other hand, from the second condition state 707 (state S3), the state transits to the violation occurrence state 709 indicating the verification property violation.

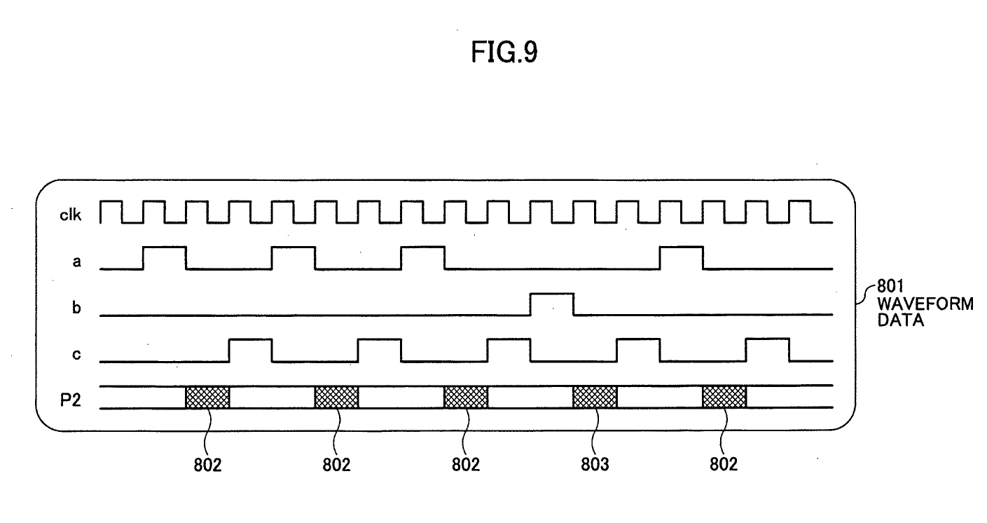

In the logic verification in accordance with the verification property, if the logic verification execution part 115 does not cancel the display of some verification property violations, for example, waveform data 801 as shown in FIG. 9 are generated. FIG. 9 is a diagram showing an example of waveform data in a case in that displays of some verification property violations are not cancelled.

The waveform data 801 shown in FIG. 9 indicates that multiple verification property violations 802 occur in the same transition path and a verification property violation 803 in another transition path occurs in the multiple verification property violations 802. It is difficult to distinguish the verification property violation 803 from the multiple verification property violations 802 in the waveform data 801.

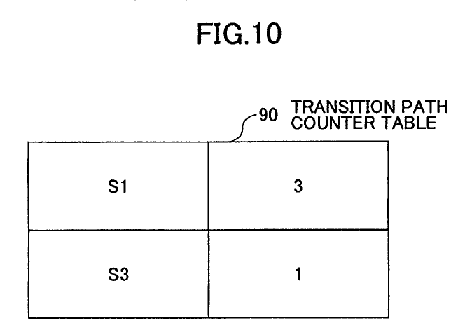

The logic verification execution part 115 includes a transition path counter table 90 as shown in FIG. 10, in order to extract a prior state just before transiting to the violation occurrence state 709 based on the state machine 702 shown in FIG. 8 and records a counter value by corresponding to the prior state.

As shown in FIG. 10, based on the state machine 702 in FIG. 8, the state S1 to be the first condition state 706 and the state S3 to be the second condition state 707 are extracted and recorded in the transition path counter table 90 as the prior state before transiting to the violation occurrence state 709. The logic verification execution part 115 confirms the prior state every time the state transits to the state S4 to be the violation occurrence state 709, and adds one to the counter value corresponding to the prior state in the transition path counter table 90. Only in a case in that the counter value indicates one after added, the logic verification execution part 115 records the verification property violation in waveform data 901.

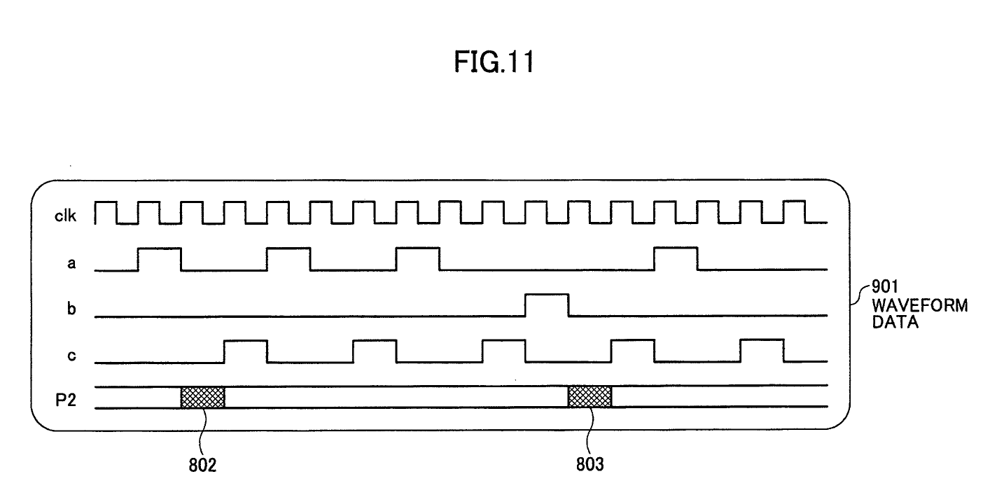

As described above, the waveform data 901 are generated as shown in FIG. 11. FIG. 11 is a diagram showing a waveform data example in a case of cancelling the displays of some verification property violations. In the waveform data 901 shown in FIG. 11, verification property violations that are the same as the ones in FIG. 9 are indicated by the same reference numerals. When waveforms are displayed based on the waveform data 901, the verification property violations 802 and 803 which are initial violations only are displayed.

Accordingly, in the present invention, referring back to FIG. 2, when the user selects a desired portion of waveforms in the waveform display 202 generated in accordance with a logic verification result conducted by using the state machine 113 based on the verification property 102, a portion of the description of the verification property 102 displayed in the property display 201 can be highlighted visually distinguishable from other portions by correlating to the desired portion of the waveform. The desired portion of the waveform on the waveform display 202 is corresponded to the portion of the description of the verification property 102 displayed in the property display 201.

Also, when the user selects a desired portion of the description of the verification property 102 displayed in property display 201, a portion of the waveforms in the waveform display 202 can be highlighted visually distinguishable from other portions by correlating to the desired portion of the description. The desired portion of the description of the verification property 102 displayed in property display 201 is corresponded to the desired portion of the waveform on the waveform display 202.

Since the desired portion selected by the user and the portion corresponding the desired portion can be displayed visually distinguishable from other portions in both the waveform display 202 and the property display 201, the user can easily analyze a cause of the verification property violation, independent of an individual's experience and knowledge of the user concerning the correspondence between the description of the verification property 102 and the waveforms.

Moreover, in the present invention, referring to FIG. 6, when the verification property violation is detected in the logic verification using the state machine 113 based on the verification property 102, it is possible to display the precondition range 402 of the waveforms corresponding to the precondition 502 of the verification property 301 in which the verification property violation is detected, visually distinguishable from other portions in the waveform display 401. Accordingly, the user can easily comprehend the precondition range 402 which is the portion of the waveforms corresponding to the precondition 502, and can properly analyze the verification property violation.

Furthermore, since the verification property violation is detected in the logic verification using the state machine 303 based on the verification property 301, it is possible to display both a description of the precondition 502 of the verification property 301 displayed in the property display 501, in which the verification property violation is detected, and a portion of the waveforms displayed in the waveform display 401 corresponding to the description of the precondition 502, so as to distinguish from other portions in both the property display 501 and the waveform display 401. Accordingly, the user can easily comprehend the correspondence between the precondition 502 displayed in the property display 501 and the portion of the waveforms where the verification property violation occurs. Therefore, the user is not required to consider the correspondence by himself and the user can effectively analyze the verification property violation.

Moreover, in the present invention, referring to FIG. 11, in a case in that the multiple verification property violations are detected in the logic verification using the state machine 702 based on the verification property 701, it is possible to suppress displaying verification property violations being caused by the same factor. Accordingly, the user is not required to analyze each of the verification property violations occurred by the same cause. Thus, the user can effectively analyze the verification property violation.

Furthermore, since only initial verification property violation in the multiple verification property violations occurred by the same cause is displayed on the waveform display based on the waveform data 901, the user can analyze without missing an important verification property violation hidden in a large amount of verification property violations caused by the same factor.

The present invention is not limited to the specifically disclosed embodiments, and variations and modifications may be made without departing from the scope of the invention.

What is claimed is:

1. A logic verification method for causing a computer to conduct a logic verification process by using a state machine based on a verification property, said logic verification method comprising the steps of:
(a) displaying at lease one waveform generated based on a logic verification result of the logic verification process;
(b) displaying the verification property; and
(c) controlling the step (a) and the step (b) in response to an operation input,
wherein the step (c) controls the step (b) to display a first respective portion of a description of the verification property corresponding to a first desired portion of the at least one waveform selected by the operation input by correlating to the first desired portion, by a different display method from other portions in response to the operation input onto the at least one waveform being displayed in the step (a).

2. The logic verification method as claimed in claim 1, wherein the step (c) controls the step (a) to display a second respective portion of the at least one waveform being displayed in the step (a) corresponding to a second desired portion of the verification property selected by the operation input correlating to the second desired portion, by a different display method from other portions in response to the operation input onto the verification property being displayed in the step (b).

3. The logic verification method as claimed in claim 2, wherein the step (c) uses syntax tree-state machine correspondence information indicating a correspondence between elements of a syntax tree generated based on the verification property and states to transit in an execution of the verification property, the states indicated by a state machine generated based on the syntax tree, and state machine-waveform correspondence information indicating a correspondence between the states of the state machine and waveform values of the at least one waveform generated in the step (a), to make portions of the at least one waveform and portions of the description of the verification of property, so that the first desired portion is correlated to the first respective portion and the second desired portion is correlated to the second respective portion.

4. The logic verification method as claimed in claim 2, wherein the step (b) displays the first respective portion and the second desired portion of the verification property to be distinguished from other portions of the verification property by using a property-syntax tree correspondence information indicating a correspondence between elements of the verification property and elements of a syntax tree generated based on the verification property.

5. A logic verification method for causing a computer to conduct a logic verification process by using a state machine based on a verification property, said logic verification method comprising the steps of:
(a) generating waveform data by executing the logic verification process and setting a first range of precondition state determined based on the state machine to the waveform data;
(b) displaying at least one waveform generated based on the waveform data; and
(c) controlling the step (b) to display the at least one waveform so that the first range of the precondition state is shown by a different display method from other ranges.

6. The logic verification method as claimed in claim 5, further comprising the step of (d) displaying the verification property,
wherein the step (c) controls the step (d) to display a first description portion of a precondition of the verification property corresponding to the first range of the precondition state displayed in the step (b) by a different display method from other description portions.

7. The logic verification method as claimed in claim 6, wherein:
the step (d) sets a second range of a postcondition state determined based on the state machine to the waveform data; and
the step (c) controls the step (b) to display the waveform so that the second range of the postcondition state is displayed by a different display method from other ranges.

8. The logic verification method as claimed in claim 7, wherein:
the step (c) controls the step (d) to display a second description range of a postcondition of the verification property corresponding to the second range of the postcondition state displayed in the step (b) by a different display method from other description portions.

9. The logic verification method as claimed in claim 5, wherein:
the step (d) sets a third range of a violation occurrence state determined based on the state machine; and
the step (c) controls the step (b) to display information indicating a violation occurrence.

10. A logic verification method for causing a computer to conduct a logic verification process by using a state machine based on a verification property, said logic verification method comprising the steps of:
(a) generating waveform data by executing the logic verification process and setting a portion corresponding to a violation occurrence state determined based on the state machine; and
(b) displaying at least one waveform based on the waveform data and displaying information indicating the violation occurrence state at the portion corresponding to the violation occurrence state,
wherein the step (a) sets portions corresponding to predetermined counts to the waveform data when the violation occurrence state caused by a same factor is detected equal to or more than the predetermined counts.

11. The logic verification method as claimed in claim 10, wherein the step (a) sets an initial portion of the violation occurrence state which is initially detected, when the violation occurrence state caused by the same factor is detected equal to or more than the predetermined counts.

12. A logic verification apparatus for conducting a logic verification process by using a state machine based on a verification property, said logic verification apparatus comprising:
a waveform display part configured to display at least one waveform generated based on a logic verification result of the logic verification process:
a property display part configured to display the verification property; and
a display control part configured to control the waveform display part and the property display part in an operation input,
wherein the display control part controls the property-display part to display a first respective portion of a description of the verification property corresponding to a first desired portion of the at least one waveform selected by the operation input by correlating to the first desired portion, by a different display method from other portions in response to the operation input onto the at least one waveform being displayed in the waveform display.
